(19) United States
(12) Patent Application Publication
(10) Pub. No.: US 2005/0044764 A1
(43) Pub. Date: Mar. 3, 2005

(54) Sign unit

(76) Inventor: Deborah Jill Decker, Mattawan, MI (US)

Correspondence Address: FLYNN THIEL BOUTELL & TANIS, P.C., 2026 RAMBLING ROAD, KALAMAZOO, MI, 49008-1699, US

(21) Appl. No.: 10/652,902

(22) Filed: Aug. 29, 2003

(51) Int. Cl. G09F 23/00

(52) U.S. Cl. 40/645; 40/611.03

(57) ABSTRACT

A sign unit to display an item comprises two parts, a display head and a stake. The display head has a front frame, a rear frame, and a base integral with and extending downwardly from the front frame. The rearward side of the front frame periphery extends forwardly and outwardly to define a cavity. The rear frame has a forward and outwardly extending lip that is detachably secured within the cavity to close the display head and securely retain an item placed between the frames. The display head can comprise various shapes, which can be interchangeable with one housing. The stake has a first acute end, and a second opposed end. The second end has integral therewith a housing and a striking ledge wherein the base is releasably mounted within the housing, and the striking ledge is used to pound or drive the sign unit into the ground.

### FIELD OF THE INVENTION

The invention relates to signs and displays, and more particularly, to signs for gardens, lawns and cemeteries.

### BACKGROUND OF THE INVENTION

People use signs in gardens and lawns for several purposes, such as to communicate an event, to express themselves and their opinions, to display the type of flora growing in their gardens, or the care and recommended watering frequency of the flora. Signs are also used in the public or commercial environment. For example, in museums, botanical gardens, outdoor art galleries to convey information about a display, parades and festivals, and to route people to desired paths and areas. The signs, whether used in private gardens or in public, are generally freely repositioned by removing them from one location, and placing them in another.

The existing art includes signs for lawns and gardens that are visible on one side. This is a problem when a double sided display is desired. The art also includes signs that are pushed into the ground by hand. This is a problem if the ground is difficult to penetrate, such as clay. These are some of the problems solved by the present invention.

### BRIEF SUMMARY OF THE INVENTION

This invention is a sign unit comprising at least one display head and a rigid stake which supports the display head thereon. The display head has up to two opposed transparent viewing sides and a base. A front frame of the display head has the base extending downwardly therefrom, wherein the sides of the base taper inwardly as the base extends downwardly to mate with a rigid stake housing on an upper end of the stake. A rear frame of the display head is detachably secured within the front frame to enclose display items within an interior storage compartment of the display head. Specifically, a rear frame periphery is detachably secured within a front frame peripheral cavity or groove. This provides a water resistant seal for a display item disposed in the storage compartment defined between the front and rear frame. Further, a plurality of different display heads may be provided which serve as interchangeable units of varying sizes and shapes.

The rigid stake has an acute or pointed first end, and an opposed second end projecting upwardly therefrom when the stake is embedded in the ground. The stake housing is disposed at the second end and receives the base of the display head therein such that the display head and stake are rigidly secured together. The rigid stake also has a striking ledge integral with the stake housing so the stake can be pounded into the ground with a hammer. The stake also has an aperture for the fastening or tying of decorative ribbons or flags.

Uses of the present invention include but are not limited to a memorial marker for gravestones, grave sites of deceased pets or placement near highways, identification for plants and flowers, and a garden row marker.

The present invention solves some problems of the prior art. Advantageous features of the present invention include: the display head being water resistant; the interchangeability, and the variation of shapes and sizes of the display heads; and the stake having a specific striking ledge for pounding the stake into the ground. Also, the sign unit is made of two pieces, each piece being a different material such that the more rigid stake can be pounded into the ground while the two frame sections of the more flexible display head are hinged together and formed integral with snap fitting connector parts.

Multiple embodiments of the sign unit are disclosed herein. It will be understood that other objects and purposes of the invention, and variations thereof, will be apparent upon reading the following specification and inspecting the accompanying drawings.

### BRIEF DESCRIPTION OF THE DRAWINGS

FIG. 1 is a front view of the sign unit.

FIG. 2 is a rear view of the sign unit.

FIG. 3 is a front view of a foldable display head of the sign unit removed from a stake, and opened.

FIG. 4 is a cross sectional side view of the display head as taken along line 4-4 of FIG. 3.

FIG. 5 is an enlarged cross sectional side view of a lip on a rear frame of the display head, a groove on a rear frame, and a living hinge of the display head in an open position as taken along line 5-5 of FIG. 3.

FIG. 6 is an enlarged cross sectional side view of the lip disposed within the groove and the living hinge folded such that the display head is in a closed position.

FIG. 7 is a side view of the sign unit.

FIG. 8 is a cross sectional top view of the stake as taken along line 8-8 of FIG. 7.

FIGS. 9 and 10 are two examples of display items that can be placed within the display head.

FIG. 11 is a side view of the stake.

FIG. 12 is a front view of the stake.

FIG. 13 is a front view of the sign unit with a decorative ribbon.

FIG. 14 is a side view of the sign unit positioned for viewing from two sides, with a ribbon in front.

FIG. 15 is a front view of a second embodiment of a display head having a generally triangular shape.

FIG. 16 is a front view of a third embodiment of a display head having an octagonal shape like a stop sign.

FIG. 17 is a front view of a fourth embodiment of a display head having a daisy-petal shape.

FIG. 18 is a front view of a fifth embodiment of a display head having a tulip-petal shape.

Certain terminology will be used in the following description for convenience and reference only, and will not be limiting. For example, the words “upwardly,” “downwardly,” “rightwardly” and “leftwardly” will refer to directions in the drawings to which reference is made. The words “inwardly” and “outwardly” will refer to directions toward and away from, respectively, the geometric center of the system and designated parts. The word “radially” refers to a direction perpendicular to a rear frame lip or a front frame cavity, and substantially in the same geometric plane as the respective frame. The word “transversely” refers to a direction substantially perpendicular to the “radial” direction, and thus substantially perpendicular to the geometric plane of the respective frame. Said terminology will include the words specifically mentioned, derivatives, and similar words.

### DETAILED DESCRIPTION

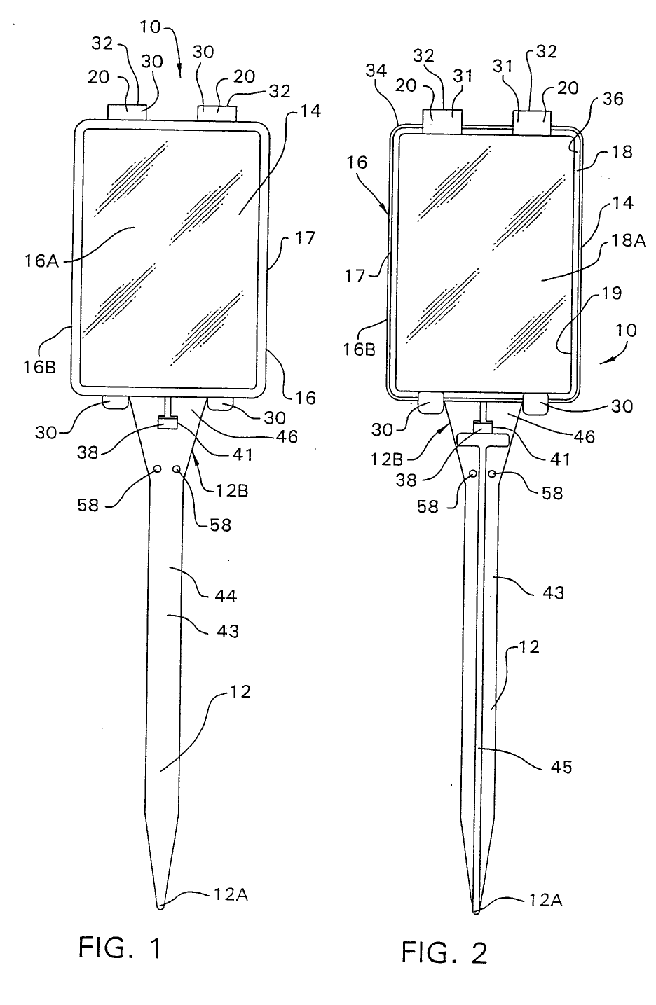

Referring to FIG. 1, a sign unit 10 is comprised of a rigid stake 12 and a display head 14, which are formed of two different materials. The rigid stake 12 is made from a rigid, fracture-resistant material, such as high-impact styrene or other high-impact material to enable driving into the ground. The display head 14 is constructed from a more flexible material, such as clarified polypropylene or other transparent materials, which permits interconnection of the sign components.

Generally as shown in FIGS. 1 and 6, the display head 14 has a substantially flat front frame 16 and a substantially flat rear frame 18 that snap-lock together to form a shallow interior compartment 27 (FIG. 6) having a water-resistant seal about the periphery thereof. In this embodiment, the display head 14 has a rectangular shape.

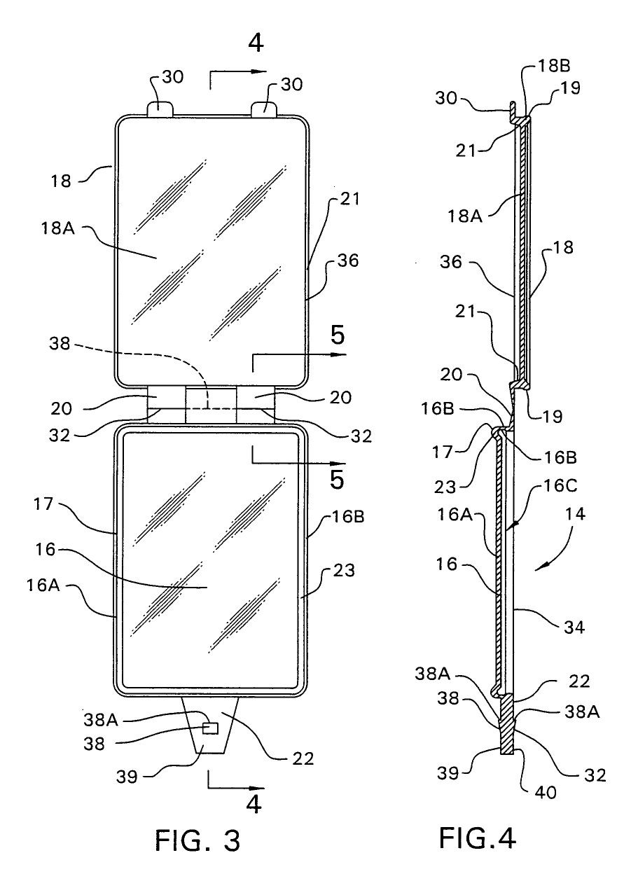

As shown in FIGS. 3, 4 and 5, the front frame 16 has a transparent, window-like, facing panel or portion 16A and a front frame periphery 17, which extends about the transparent portion 16A. The front frame periphery 17 has a forwardly and radially outwardly extending corner portion 23, which defines a rearwardly and inwardly opening peripheral cavity or groove 24 on the rearward side 62 of the front frame 16. The front frame periphery 17 further extends rearwardly from the transparent facing panel or portion 16A to define a peripheral side wall 16B thereby defining the four sides of a shallow frame cavity 16C. The frame cavity 16C is adapted to receive the rear frame 18 therein and define a portion of the interior compartment 27 as will be described in further detail.

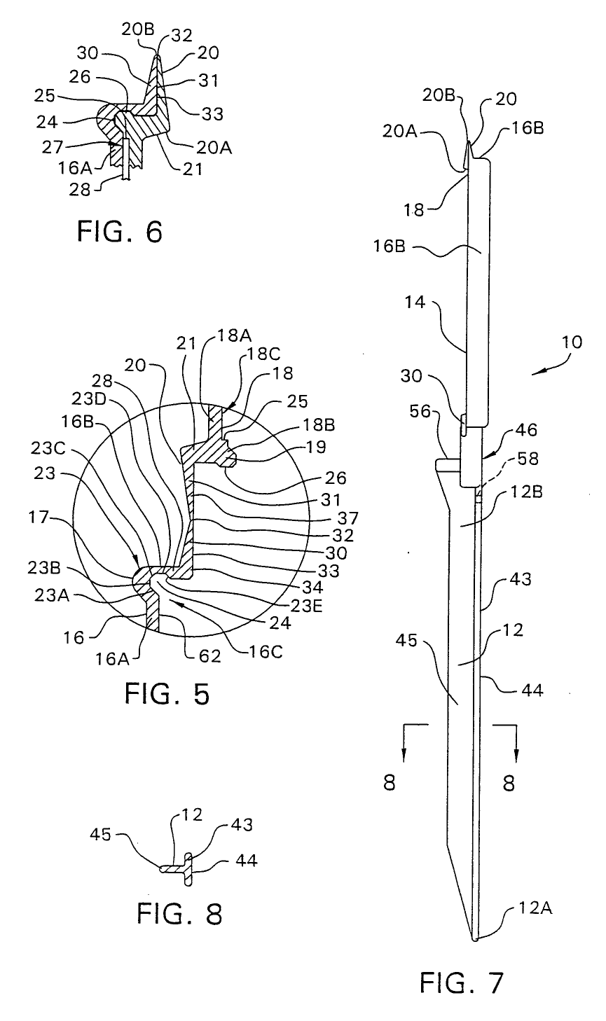

The rear frame 18 has a transparent, window-like, facing panel or portion 18A and a rear frame periphery 19 extending about the transparent portion 18A and projecting forwardly when in the closed position of FIG. 6 to define a side wall 18B and a shallow frame cavity 18C (FIG. 6). The outer edge of the side wall 18B projects radially outwardly to form a peripheral lip 26 adapted to be detachably secured within the peripheral cavity 24 of the front frame 16 in snap fitting engagement therewith. Accordingly, in the open position of FIGS. 4 and 5, the lip 26 extends rearwardly and outwardly and in the closed position of FIG. 6, the lip 26 snap fits forwardly into the cavity 24. As shown in FIGS. 3, 4 and 5, a rear frame ridge 21 projects rearwardly from the transparent portion 18A about the periphery of the rear frame 18.

More particularly, as shown in FIGS. 5 and 6, the corner portion 23 of the front frame 16 is further comprised of an inward cut 23A, a forward cut 23B, a forward-outer cut 23C, an outer cut 23D, and a rearward-outer cut 23E. The cuts 23A-23E define facet-like surface portions although these surface portions also may have a smooth, continuous curvature.

The lip 26 of the rear frame 18 is adapted to cooperate sidewardly with at least the cut 23A in the radial or transverse direction that extends generally parallel to the plane of the facing panel 16A, and simultaneously with at least the cut 23E in a forward direction for bi-directional contact between the lip 26 and groove 24. Further, when the lip 26 is disposed within cavity or groove 24, the lip 26 may cause compressive forces throughout each of the surfaces of the corner portion 23.

As seen in FIG. 6, the peripheral lip 26 therefore fits snugly within the peripheral groove 24 entirely about the periphery of each of the front frame 16 and the rear frame 18. This is accomplished by seating the rear frame 18 within the cavity 16 until the lip 26 snaps into the groove 24. Since the display head 14 is formed of a relatively resilient material, the side wall 18B and the associated lip 26 can deflect inwardly while the side wall 16B can deflect outwardly as the lip 26 slides rearwardly across the inside face of the side wall 16B. Once the lip 26 slides past the corner of the rearward-outer cut 23E, the lip 26 is able to seat radially outwardly and forwardly into the groove 24 wherein the side walls 16B and 18B return partially or completely to the undeflected condition of FIG. 5. The lip 26 thereby seats within the groove 24.

The contact between the lip 26 and the rearward-outer cut 23E serves to draw the rear frame 18 into the front frame 16 and restrain the rear frame 18 rearwardly to prevent rearward removal from the front frame 16. Additionally, the lip 26 cooperates with the inward cut 23A which restrains inward deflection of the rear frame wall 18B generally along the plane of the transparent portion 18A. Preferably, the lip 26 is pressed outwardly by the inward cut 23A to urge the rear frame side wall 18B outwardly towards the front frame side wall 16B to promote contact therebetween and minimize if not eliminate any peripheral clearance spaces which would permit leakage of moisture or precipitation into the interior compartment 27. As such, the construction of the lip 26 and the groove 24 provides an improved water resistant seal to protect any display items stored within the compartment 27.

It is possible that only one of said cuts 23A, 23B, 23C, 23D, 23E is provided for contact which is still sufficient to cause a water resistant seal and snap-fit connection. Thus, if the lip 26 is compressed against only one of said cuts, for example the forward cut 23B, a water-resistant seal would still be created. In other words, it is possible for the lip 26 to cooperate with only the forward cut 23B, and not the rearward-outer cut 23E and still create a water resistant seal. Further, the lip 26 can cooperate with two or more of said cuts 23A, 23B, 23C, 23D or 23E for the bi-directional contact and sealing discussed above.

Additionally, the cooperation of the lip 26 and groove 24 effectively define a snap fit connection about the entire peripheries of the cooperating front and rear frames 16 and 18. This snap fit connection resists separation of the front and rear frames 16 and 18 while still permitting opening of the front and rear frames 16 and 18 to provide access to the interior compartment 27.

Preferably, the front and rear frames 16 and 18 are formed integrally together with a unitary construction wherein the front and rear frames 16 and 18 are hingedly joined together by a hinge arrangement. As shown in FIG. 3, the front frame 16 and rear frame 18 may lie flat in an unfolded condition and may thereafter be folded together as shown in FIGS. 1 and 6 such that the peripheral lip 26 and groove 24 snap fit together. As shown in FIGS. 1, 6 and 7, the hinge arrangement is defined by at least one and preferably two living hinges 20 which join the adjacent edges of the front and rear frames 16 and 18.

More particularly as shown in FIGS. 5, 6 and 7, each living hinge is defined by a front hinge section 30 which projects upwardly from the front frame 16 and a rear hinge section 31 which projects upwardly from the rear frame 18. Substantially midway between each of the front and rear hinge sections 30 and 31, a living hinge pivot line 32 is defined which is the line along which the hinges 20 pivot. The pivot lines 32 are aligned horizontally with each other. Each of the front and rear hinge sections 30 and 31 have a progressively decreasing thickness as illustrated in FIG. 5 and join together at the pivot line 32 which is the region in which the thickness of each living hinge 20 is thinnest. Therefore, even though the hinge sections 30 and 31 are formed integral with each other, the thin region of the pivot line 32 limits pivoting only along this pivot line 32.

More particularly as to the front hinge section 30, this hinge section has an interior face 33 which generally projects vertically and is arranged flush with the edge 34 of the front frame side wall 16B.

As for the second hinge section 32, this hinge section is offset rearwardly from the terminal edge 36 (FIG. 4) of the rear frame side wall 18B. As such, the inner face 37 of this second hinge section 31 is essentially flush with this rear edge 36 such that when the front frame 16 and rear frame 18 are folded together in the closed position of FIG. 6, the rear frame 18 can seat fully within the front frame 16 with the opposing faces 33 and 37 of the hinge sections 30 and 31 being disposed in facing and close or abutting contact. This thereby orients the pivot line 32 directly above and aligned with the terminal edge 34 of the front frame 16. Additionally, the two living hinges 20 are disposed sidewardly adjacent from each other such that the two pivot lines 32 are aligned coaxially with each other to thereby define a generally horizontally hinge axis 38 identified in phantom outline in FIG. 3 to define a common hinge axis about which the rear frame 18 may swing relative to the front frame 16.

Furthermore, since the hinge sections 30 and 31 project upwardly when in the closed condition and are joined by the folded pivot line 32, this effectively prevents water from seeping downwardly into the region of the opposed surfaces 33 and 37 which leakage could otherwise migrate into the interior compartment 28.

Referring to FIGS. 6 and 7, the extending portion 23 also has a spacer-offset 25 that, when the display head 14 is closed, spaces the front frame transparent portion 16A from the rear frame transparent portion 18A to define the compartment 27 for placement of an item 28 (FIG. 6) therein. Thus, the size of the offset 25 conforms to the spacing or depth of the compartment 27 and maintains uniform separation between the transparent portions 16A and 18A about the peripheries thereof.

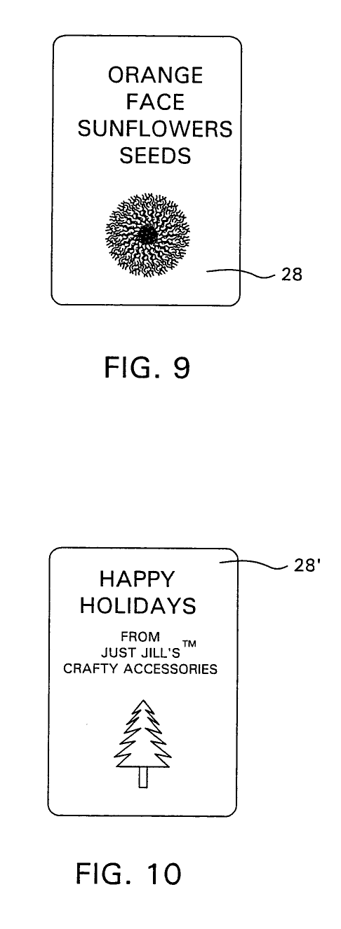

As shown in FIG. 7, in addition to defining the cavity or groove 24, the front frame periphery 17 extends rearwardly to form the rim-like side wall 16B. When the lip 26 is within the cavity 24, the display head 14 is closed, and the side wall 16B surrounds the rear frame 18. This creates the water resistant seal between the lip 26 and the cavity 24, wherein the display head 14 is constructed to hold an item 28, 28′ (FIGS. 9 and 10) which is thereby protected from the elements.

Referring to FIGS. 2 and 7, a pair of release tabs 30 extends rearwardly and downwardly from a bottom portion of the rear frame 18 in laterally spaced relation. To open the display head 14, one or both of the release tabs 30 are forced manually rearwardly relative to the front frame 16 to separate the lip 26 of the rear frame 18 from the cavity 24 of the front frame 16. The rear frame 18 pivots relative to the front frame 16 via the living hinges 20. The tabs 30 are spaced laterally from opposite sides of the stake 12 during use to balance opening forces on the tabs 30 relative to the stake 12 centered therebetween and permit opening of the display head 14 even when the display head 14 is mounted on the stake 12.

Referring to FIG. 3, a downward projecting base 22 extends downward from the transparent front frame 16 and is formed integral therewith. The base 22 has sides that taper inwardly as they extend downwardly.

More particularly, as shown in FIG. 4, the base 22 has an outwardly protruding catch 38 disposed on each of the front face 39 and back face 40 for releasably engaging a respective aperture 41 of a rigid stake support section or housing 46, as best seen in FIGS. 1 and 2. FIG. 4 shows the shape of the catch 38 as having a substantially horizontal notch 38A, which faces upwardly and downwardly tapers to a lower part of the base 22. While the two catches 32 are preferred, only one catch 32 could be provided on either the front face 39 or back face 40.

As shown in FIG. 7, the rigid stake 12 has a front or side wall 43 defining a flat face 44, and a rearwardly extending rib 45, which forms a T-shaped cross section, as shown in FIG. 8. The T-shaped cross section rigidities the stake 12 and helps prevent the stake 12 from rotating when it is placed in the ground. The stake 12 has an acute or pointed first end 12A which may be driven into the ground during use and an opposed second end 12B projecting upwardly to define a support section.

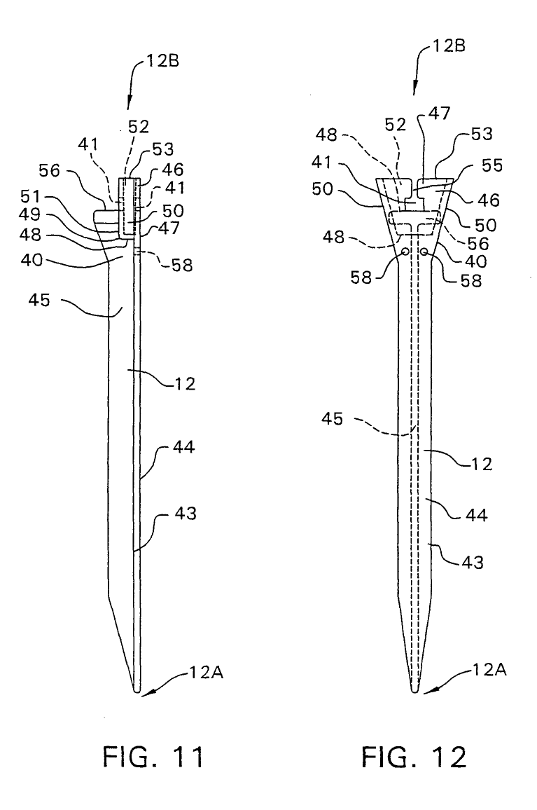

Referring to FIGS. 11 and 12, the second end 12B has a housing 46 that is formed integral with the stake 12 and is adapted to receive the base 22 in a bayonet connection so that the display head 14 may be rigidly supported on the stake 12. The housing 46 has a housing front panel or wall 47 contiguous with the flat face 44, a bottom panel or wall 48 extending rearwardly from a bottom of the front panel 47 terminating in a rear edge 49, two inclined side walls 50 extending upwardly and outwardly from the bottom panel 48, and a back panel or wall 51 extending upwardly from the rear edge 49 and substantially parallel with said front panel 47. Thus, housing 46 defines a tapered chamber 52 having a rectangular shaped open top 53 for receiving the base 22.

As shown in FIG. 1, the tapered base 22 is snugly mounted within the tapered housing 46. The tapered fit allows for an easier fit between the base 22 and the housing 46, as compared with a square fit (requiring parts with right angles) base and housing. The tapered fit also provides for a more secure fit because of the increased contact between the tapered base 22 and tapered housing 46 in both the vertical and horizontal direction, compared with a non-tapered base and housing.

Referring to FIGS. 11 and 12, both of the housing front panel 47 and the back panel 51 have a rectangular aperture 41 in which the catches 38 of the base 22 are releasably engaged. Alternatively, only a single aperture 41 would be provided if only one catch 38 is used.

Each aperture 41 has a generally horizontal upper edge which faces downwardly and defines a stop surface against which the face of the notch 38A is adapted to abut. In particular, when the base 22 is seated completely within the housing chamber 52, each catch 38 slides downwardly until it is aligned with the aperture 41 after which, the respective housing panel 47 or 51 shifts horizontally relative to the catch 38 such that the catch face 38A abuts against the opposing surface of the upper edge of the aperture 41. This prevents removal of the base 22 from the housing chamber 52.

Preferably, the front panel 54 is separated in the vertical direction, beginning at the top edge and extending downwardly, to define a substantially vertically disposed slot 55 that downwardly terminates at the rectangular aperture 41. The slot 55 and aperture 41 allow the front and/or back panels 47, 51 to flex outwardly away from the catch 38 when the base 22 is inserted or removed from the housing 46. As such, as the base 22 is inserted downwardly into the chamber 52, the inclined camming surface of the catch 38 presses the opposite housing panels 47 and 51 outwardly which allows downward shifting of the catches 52 between these panels. Once the catches 38 are aligned with the apertures 41 as referenced above, the front and back panels 47 and 51 are able to resiliently restore themselves to their original undeflected condition wherein the catches 48 now abut against the opposing upper edges of the respective apertures 41. As such, the display head 14 is readily mountable to the stake 12.

The slots 55 further facilitate removal of a display head 14 from the stake 12 since it allows insertion of a tool and more readily permits deflection of the front and back panels 47 and 51. Moreover, the slots 55 may also be omitted such that the panels are solid in the region of the slots 55. This, however, makes removal of the display head 14 from the stake 12 more difficult and typically prevents removal of the display head 14.

The sign unit 10 is further adapted for embedding within a support surface which typically is the ground. The stake 12 as discussed in more detail herein is driven downwardly so that the lower stake end 12A is embedded within the ground while the upper stake end 12B remains exposed for engagement of the display head 14. As described in further detail herein, the stake 12 may first be inserted in the ground and then the display head 14 mounted thereto by insertion of the base 22 into the chamber 52. Alternatively, the display head 14 may already be engaged with the stake 12 either before first use or upon repositioning of the sign unit 10 from one location to another. With this arrangement, the sign unit 10 of the invention is still readily capable for being driven into the ground by a suitable pounding device such as a hammer or the like.

More particularly, to permit downward driving of the stake 12 into the ground, a striking ledge 56 extends horizontally and rearwardly from the back panel 51, and is disposed below the aperture 41 of the back panel 51. The ledge 48 is offset sidewardly of the back panel 51 to allow the ledge 51 to be struck by a hammer or the like without damaging the front and back panels 47, 51, which are relatively thin and accordingly, are less strong and rigid. As such, the ledge 51 may be struck even with the display head 14 mounted on the stake 12.

The location for the rib 45 provides support to withstand high impact and long term pounding on the striking ledge 51. The rib 45 is molded integral with and extends downward from the striking ledge 51 to thereby provide support for the striking ledge 51. As such, vertical forces on the ledge 51 from a hammer or other implement are supported by the vertically elongate rib 45.

Additionally, the rib 45 projects upwardly above the rear housing edge 49 and is molded integral with at least a lower portion of the bottom panel 48. Further, the striking ledge 51 is formed integral with and projects rearwardly from the lower half of the bottom panel 48, just below the respective aperture 41. As such, the rib 45 and ledge 56 serve to rigidify the stake housing 46 and in particular, the lower portion of the back panel 51.

As the rib 45 extends downwardly from the ledge 51, the rib 45 tapers inwardly toward the flat face 44. As the rib 45 approaches the acute end 12A, it tapers toward the flat face 44 to define a point.

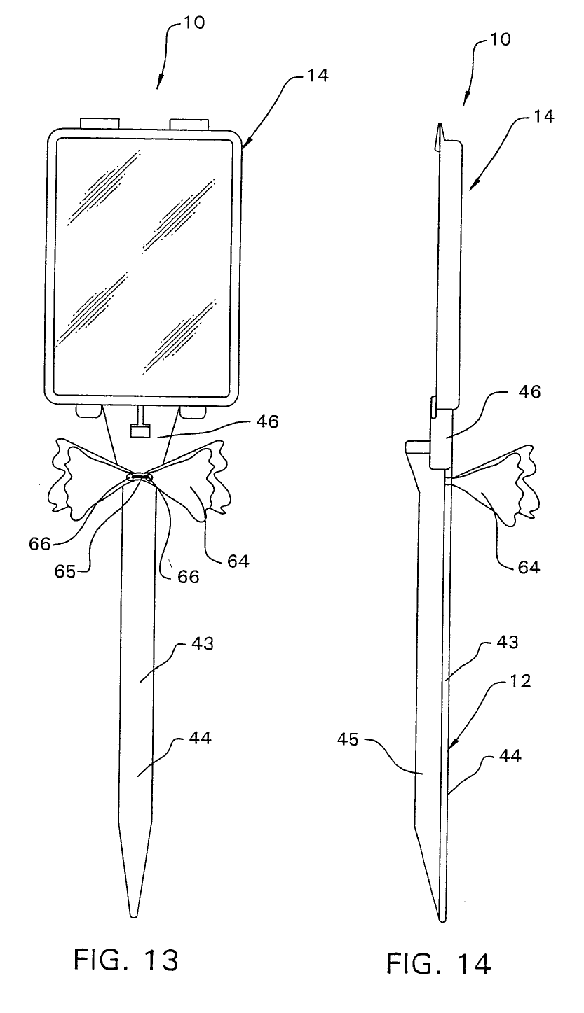

In order to accommodate mounting of decorative accents to the sign unit 10, the rigid stake 12 has a pair of holes 58 disposed near the second end 40, below the housing bottom panel 48. The holes 58 can be used for securing a ribbon 64 to the sign unit 10, as shown in FIGS. 13 and 14. The ribbon 64 is secured with a small wire 65 or other fastener wrapped around the ribbon 64, and placed through holes 66 in the ribbon 64 and the aligned holes 58 in the stake 12.

To use the invention, an item 28 (FIG. 9) is placed within the display head 14. This can be performed while the display head 14 is engaged to the rigid stake 12 or when the display head 14 is removed therefrom.

The display head 14 may be separated from the rigid stake 12 by moving the display head 14 upwardly relative to the stake 12. Twisting the display head 14 with a rotational motion about the vertically-extending longitudinal axis of the stake 12 causes increased flex of the housing 42, and thus assists in removing the display head 14 from the stake 12.

To place an item 28, 28′ within the display head 14, the release tab 30 is pushed back to release the lip 26 of the rear frame 18 from the cavity 24 of the front frame 16, and thus open the display head 14.

In one embodiment, an item such as a seed package 28 (FIG. 9), or a 3″×5″ insert 28′ (FIG. 10), such as a picture, photograph or decorative card can be placed within the rim 16B and adjacent the front frame 16. Then the lip 26 around the rear frame periphery 19 is pushed within the cavity 24 to close the display head 14. The base 22 of the display head 14 is then inserted into the housing 46 until the catch 38 is releasably engaged with the aperture 41 of the housing 46. As such, the display items 28 or 28′ thereby are visible through the transparent portions 16A or 18A of the front and rear frames 16 and 18. For conventional seed packages of FIG. 9 which are commercially available, these items 28 are double-sided and thereby are viewable through both transparent sides of the display head 14. For the display item 28′, this item may be one-sided which is still viewable through either the front frame or rear frame depending upon the orientation of the item 28′ when fitted into the compartment 27. For example, the display item 28′ may be a photograph or a printed graphical card created by any means such as a computer and associated printer.

Next, the tapered end 12A of the rigid stake 12 is positioned at an insertion point above the soil or other material in which it will be placed. In this position the sign unit 10 can be pushed in the ground or soil. If the ground is difficult to penetrate, the striking ledge 56 is struck with a hammer to pound the sign unit 10 into the ground or soil. Thus the geometric planes containing the front and rear frames 16, 18 are substantially parallel with the longitudinal axis of the stake 12.

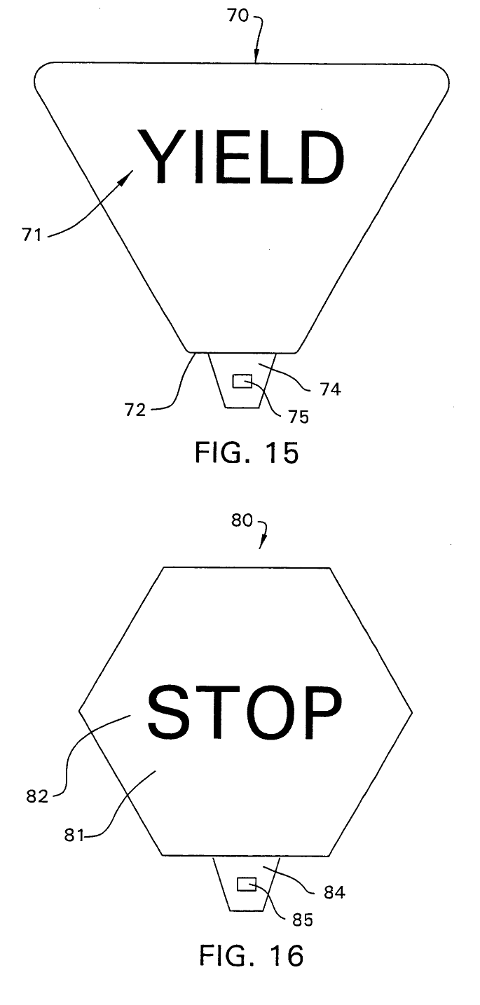

In addition to a rectangular shape shown in FIGS. 1 and 2, a sign system may be provided which comprises one or more universal stakes 12 which are provided in combination with any of a variety of different display heads. These display heads can have various interchangeable shapes such as triangular, octagonal, daisy-petal shaped, or tulip-petal shaped, as shown in FIGS. 15-18, respectively. These alternate display head constructions use common structural features with the following being a general discussion of the components thereof.

The triangular shaped head 70 preferably is molded with a constant thickness and a predefined color such as yellow. The head 70 also has indicia 71 such as “yield” printed thereon. The lower edge 72 of the head 70 has a base 74 projecting downwardly therefrom for engagement with the stake 12. A catch 75 is provided on each opposite side to function the same as the catch 38.

As to the octagonal head 80 illustrated in FIG. 16, the display head 80 joins to a stake 12 by a base 84 having a catch 85 on each side thereof. The face 81 is also imprinted with indicia 82 such as the word “stop”.

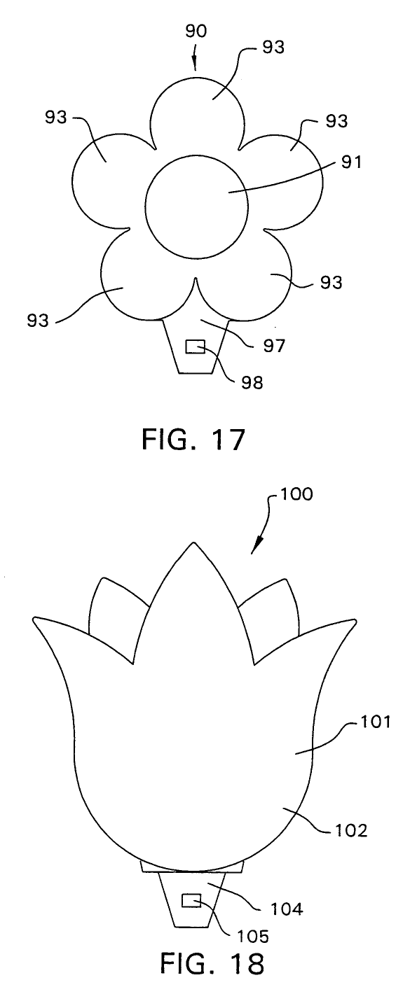

A further display head 90 is illustrated in FIG. 17 which has a daisy-petal shape. In this arrangement, the display head 90 has a circular center section 91 and peripheral, petal-like decorative projections 93 disposed circumferentially one next to the other. The lower-most petals 93 further include a base 97 having a catch 98 on the opposite sides thereof for engagement with the stake 12.

A further display head 100 is illustrated in FIG. 18 as having a tulip shape. The head 100 includes a downwardly projecting base 104 having a catch 105 on each opposite side thereof.

With all of the alternate display heads illustrated in FIGS. 15, 16, 17 and 18, each of these display heads 70, 80, 90 and 100 are interchangeable and selectively engagable with any stake 12. Thus, the invention may relate to a system of display heads which is provided in combination with a universal stake 12 or a plurality of such stakes 12 to define multiple signs having different shapes. The interchangeability of the display heads 14, 70, 80, 90 and 100 allows for quick placement or replacement of different shaped display heads for different occasions.

As to any of the display heads of FIGS. 15-18, these display heads 70, 80, 90 and 100 may be formed from front and rear frames which are joined together by living hinges. The front and rear frames have the same basic cross sectional shape as that illustrated in FIGS. 4, 5 and 6. The front frame further would be transparent rather than a solid color and be formed with the downwardly projecting base having a catch on each opposite side thereof which base is formed substantially the same as the bases described above.

With the different shapes, different shaped flat items may be inserted therein. For example, the triangular display head 70 could be included with a display item that has the same general appearance as a conventional road traffic yield sign wherein the sign unit would be displayed next to a walkway for a functional, decorative or humorous effect. Also, the display head 80 may have a transparent front frame and include an item which has the appearance of a traffic control stop sign. In the case of the daisy-petal head 90, the front frame would define the center section 91 which may be opened to provide access to a thin, generally circular storage compartment in which an item may be stored such as a picture or the like.

Further, the items placed within the compartments 27 of the display heads are virtually limitless. The item can be substantially the same shape as the display head, but it need not be. For example, when using the daisy-petal shaped display head 90, the item can be circular shaped to substantially fill a central transparent portions of the display head 90. Alternatively, the item placed in a compartment of the daisy-petal shaped display head 90 can be square.

In a further embodiment, the base 22 extends downwardly from said rear frame 18 rather than the front frame 16. In this embodiment the release tabs 30 would extend forwardly and downwardly from said front frame 16.

The preferred embodiment has the following size dimensions for some of the invention's elements; the rigid stake 12 is about 26.04 cm (10.25 inches) long; the front frame 16 is about 13.65 cm (5.38 inches) high×9.53 cm (3.75 inches) wide; the cavity or groove 24 extends forward about 1.59 mm (0.063 inches), and outward about 1.59 mm (0.063 inches); and the rim 58 extends rearward about 8.73 mm (0.34 inches).

Also, the height and width dimensions described above can be varied or transposed. For example the front frame 16 can measure about 9.53 cm (3.75 inches) high×13.65 cm (5.38 inches) wide. Further, the display head 14 can have embodiments in which it can hold items 28 up to 1.27 cm (0.5 inches) thick.

Further, the display head 14 can be mounted in the housing 42 having the front frame 16 rearward of the rear frame 18. In other words, the display head 14 can be rotated 180° from an embodiment described above.

Although a particular preferred embodiment of the invention has been disclosed in detail for illustrative purposes, it will be recognized that variations or modifications of the disclosed apparatus, including the rearrangement of parts, lie within the scope of the present invention.

1. A sign unit comprising:
a stake projecting downwardly for engagement with a support surface and a second end projecting upwardly to define a support section; and
a display head having substantially flat front and rear frames which have facing panels and are engagable in facing relation with each other to define a compartment therebetween, said facing panel of at least one of said front frame and said rear frame being transparent to permit viewing of an item within said compartment, said display head being formed separate from said stake and including a base which is engagable with said support section of said stake such that said display head is supported on said stake and extends upwardly therefrom, said front frame and said rear frame including peripheral edge portions which extend longitudinally about the respective periphery of each of said front frame and said rear frame wherein an elongate length of at least one of said peripheral edge portions of said front frame and said rear frame projects toward the other of said peripheral edge portions into interfitted engagement with a respective length of said other peripheral edge portion to engage said front frame and said rear frame one with the other wherein said interfitted peripheral edge portions define a water resistant seal extending about the peripheries of said front frame and said rear frame.

2. The sign unit according to claim 1, wherein said peripheral edge portion of one of said front frame and said rear frame comprises an elongate peripheral lip which projects transversely away from said facing panel in one direction, and said peripheral edge portion of the other of said front frame and said rear frame comprises an elongate peripheral groove which receives said elongate peripheral lip therein in snap-fitting engagement.

3. The sign unit according to claim 2, wherein said elongate peripheral groove and said elongate peripheral lip cooperate with each other so as to draw said elongate peripheral lip and said elongate peripheral groove sidewardly and transversely toward each other along the length thereof to define said water resistant seal.

4. The sign unit according to claim 1, wherein one of said peripheral edge portions which extend about the respective periphery of each of said front frame and said rear frame comprises an elongate peripheral lip extending about substantially the entire periphery of one of said front frame and said rear frame and the other of said peripheral edge portions comprises an elongate closed groove extending about substantially the entire periphery of the other of said front frame and said rear frame wherein said lip and groove interfit to define a water resistant seal, said base being located at a lower end of said display head and being received by said support section at the second end of said stake, and said front frame being openable relative to said rear frame to enable placement of a flat display item is within said compartment.

5. The sign unit according to claim 1, wherein said front frame periphery extends rearwardly to form a rim, and said rear frame periphery extends rearwardly to form a rear frame ridge, a living hinge connected at one end to a top portion of said rim and at an opposed end to a top portion of said rear frame ridge, said living hinge folding therebetween whereby said frames are hingedly connected to open and close, and said rear frame ridge is disposed within said rim when closed.

6. The sign unit according to claim 5, wherein a release tab extends rearwardly and downwardly from a bottom portion of said rear frame ridge to permit manual separation of said rear frame from said front frame.

7. A sign unit comprising:
a thin display head having a front frame and a rear frame which are engagable one with the other to define a compartment therebetween, at least one of said front frame and said rear frame having a transparent portion to permit viewing of an item disposed within said compartment, said display head further including a base which is formed integral with one of said front frame and said rear frame and extends downwardly therefrom, said base having an outwardly protruding catch; and
a stake having a first end which projects downwardly for engagement with a support surface and an opposite second end which projects upwardly for supporting said display head thereon, said second end including a stake housing formed integral with said stake, said stake housing having a housing front panel which faces forwardly and a housing back panel which is generally parallel to and disposed rearwardly from said housing front panel to define a chamber between said housing front and back panels that opens upwardly to receive said base downwardly therein, at least one of said housing front panel and said housing back panel having an aperture formed therethrough which is adapted to receive said catch of said base therein and maintain said base engaged with said stake housing, and wherein said front and rear frames of said display head are disengagable from each other to permit access to said compartment while said base is engaged within said chamber.

8. The sign unit according to claim 7, wherein said base of said display head is disengagable from said stake housing for replacement with a second thin display head having a non-rectangular shape, and wherein said flat face has a hole therethrough disposed near said second end below said housing front panel which is adapted to receive a fastener.

9. The sign unit according to claim 7, wherein said stake housing has two sides integrally disposed between said housing front panel and said housing rear panel, each of said sides tapering outwardly upwardly and said base having sides that taper inwardly and extend downwardly such that said base substantially mates with said stake housing to secure said base within said stake housing so that a lower end of said display head is located proximate the second end of said stake.

10. A sign unit according to claim 7, wherein said aperture is formed continuous with a slot extending vertically from said aperture to an upper edge of said one of said housing front panel and said housing back panel in which said aperture is formed.

11. The sign unit according to claim 10, wherein each of said housing front panel and said housing back panel includes one said aperture and one said slot and said base of said display head includes one said catch protruding outwardly from each of opposite sides of said base for engagement with said apertures.

12. The sign unit according to claim 7, wherein each of said housing front panel and said housing back panel includes one said aperture and one said slot and said base of said display head includes one said catch protruding outwardly from each of opposite sides of said base for engagement with said apertures.

13. A sign unit system comprising:
at least one stake having a tapered first end which projects downwardly for engagement with a support surface and an opposite second end which projects upwardly and includes a support section thereon; and
a plurality of interchangeable display heads wherein each of said display heads has a different shape from each other and has a base which projects downwardly at a lower end and is removably engagable with said support section at the second end of said stake to permit engagement of any one of said display heads with said stake while permitting removal of said engaged display head and replacement with an alternative one of said display heads.

14. The sign unit according to claim 13, wherein said plurality of said display heads comprise triangular, octagonal, daisy-petal, and tulip-petal shapes.

15. A sign unit according to claim 14, wherein each of said display heads has a front frame and a rear frame which is engagable with said front frame in facing relation to define a shallow compartment therebetween, at least one of said front frame and said rear frame having a transparent portion to permit viewing of an item within said compartment, said compartment being adapted to store at least one of a plurality of different display items therein, and wherein said front frame and said rear frame are closed about respective peripheries thereof to prevent entry of objects into said compartment and are releasably engagable to permit opening of said display head while mounted to said stake and permit insertion of any one of said display items into said compartment only when said front and rear frames are opened.

16. A sign unit according to claim 15, wherein said front frame and said rear frame of each of said display heads are hingedly connected together to permit opening and closing of said display heads by folding said front frame and said rear frame relative to each other.

17. A two-piece sign unit comprising:
a display head having front and rear frames which are engagable with each other in opposed relation to define a compartment therebetween which is adapted to receive a display item therein, at least one of said front frame and said rear frame having a transparent portion to permit viewing of a display item stored within said compartment, and side edges of said front frame and said rear frame including cooperating engagement parts extending longitudinally along respective peripheries of said front and rear frames wherein said display head is formed of a first material which permits resilient deflection of said cooperating engagement parts so that said cooperating fastening parts lockingly interfit along respective elongate lengths thereof for removable engagement of said front frame with said rear frame, said display head further including a base at a bottom portion that projects downwardly therefrom; and
a vertically elongate stake having a first end projecting downwardly for embedding within the ground and an opposite second end which projects upwardly, said second end including a stake housing formed integral with said stake which defines a chamber that opens upwardly and receives said base of said display head downwardly therein such that said display head is supported by said stake, said stake including a striking ledge formed integral with said stake proximate said stake housing, said striking ledge extending horizontally and outwardly away from said stake housing to define an exposed upward facing striking surface which is disposed sidewardly of said chamber and a bottom end of any said display head mounted thereon, said stake being formed of a second material which is more rigid than said first material to withstand striking of said striking ledge by a striking device to permit driving of said stake into the ground.

18. The sign unit according to claim 17, wherein said display head is clarified polypropylene.

19. The sign unit according to claim 17, wherein said stake is high-impact styrene.

20. The sign unit according to claim 17, wherein said stake is defined by a side wall extending along the length of said stake and a reinforcing rib which projects from one face of said side wall along the length thereof to define a T-shaped cross-section as viewed from above, said striking ledge having said rib projecting downwardly therefrom such that said striking ledge is reinforced vertically by said rib.

21. The sign unit according to claim 20, wherein said chamber is separated sidewardly from said striking ledge by an intermediate chamber wall, said chamber wall being supported sidewardly by said striking ledge and said rib to rigidify said chamber wall and provide support to said base when disposed within said chamber.

22. The sign unit according to claim 21, wherein said stake housing includes an outer wall which is spaced from said intermediate wall to define said chamber therebetween, at least one of said intermediate wall and said outer wall including an aperture and said base including at least one catch which projects outwardly therefrom and engages said aperture to retain said base located at the bottom end of said display head within said chamber of said stake housing.
